(19) United States
(12) Patent Application Publication
(10) Pub. No.: US 2005/0253823 A1
(43) Pub. Date: Nov. 17, 2005

(54) Information processing device

(75) Inventors: Satoshi Kazama, Kawasaki (JP); Yoshiyasu Nakashima, Kawasaki (JP); Hideyuki Motoyama, Kawasaki (JP); Hiroshi Yamada, Kawasaki (JP); Mayumi Uchida, Kawasaki (JP); Makoto Sawaguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/184,848

(22) Filed: Jul. 20, 2005

Related U.S. Application Data
(63) Continuation of application No. PCT/JP03/07587, filed on Jun. 13, 2003.

(51) Int. Cl. G09G 5/00

(52) U.S. Cl. 345/184

(57) ABSTRACT

An information processing device capable of starting an application by a simple operation upon power turning on or return from the suspend state or halt state and not inhibiting reduction of the device size. The information processing device includes an application selection dial rotatably attached to a housing and capable of stopping at a plurality of selection positions, a position detector for detecting the selection position of the application selection dial, and an application automatic starter that starts the application among a plurality of applications, the application being allocated to the selection position detected by the position detector at time of start-up.

This is a continuation of International Application PCT/JP2003/007587, with an international filing date of Jun. 13, 2003.

### TECHNICAL FIELD

The present invention relates to an information processing device configured for stress-free use of the applications installed therein.

### BACKGROUND ART

It has been proposed that information processing devices such as personal computers (“PC” or “PCs”) or personal digital assistants (“PDA” or “PDAs”) can be provided with, in addition to a keyboard for data input and operating buttons, specialized buttons for application start.

Such specialized buttons for application start, in the case of a desktop PC, are provided in appropriate locations on a keyboard upper surface. In the case of a laptop PC, such specialized buttons for application start can be provided on the same surface as a keyboard, or else the edge or rear surface of a liquid panel display. In the case of a PDA, mobile computer or other miniaturized information processing device, such specialized buttons for application start can be provided on the same surface as a liquid panel display, or else a rear or side surface.

When such specialized buttons for application start are provided, they must be given a certain size to facilitate operation; to provide a plurality of buttons for a plurality of applications, a larger area is required for disposing such buttons, impeding miniaturization of the information processing device. In particular, for laptop, PDAs and other miniaturized information processing devices, there is only limited space for disposing buttons, and if priority is given to operability, miniaturization becomes difficult; to miniaturize a device, the buttons must be reduced in size or in number, in either case sacrificing operability.

Further such information processing device are platforms for use with a wide range of applications, and from among the applications installed therein, after its respective operating system has been started, that application that is to be executed must be selected and started. Therefore, when for example a user wishes to use only music playback function, such user has to undertake the involved operation of first starting the information processing device and then selecting the icon for the targeted application from the desktop or start menu.

### DISCLOSURE OF THE INVENTION

The information processing device according to a first aspect of the present invention is an information processing device onto which a plurality of applications can be loaded, comprising an application selection dial rotatably attached to a housing and capable of stopping at a plurality of selection positions, a position detector for detecting the selection position of the application selection dial, and an application automatic starter that starts an application among a plurality of applications, the application being allocated to the selection position detected by the position detector at time of start-up.

In such a case, if the information processing device is started in a state where the application selection dial is positioned at the corresponding selection position for the application that a user wants to start, the desired application will start up automatically, allowing speedy use of such application. Because the application selection dial can be designed to handle a plurality of applications, there is no need for many operating buttons, the device can be miniaturized and operation can be simplified.

The information processing device according to a second aspect of the present invention is the information processing device according to the first aspect, wherein the application automatic starter starts an application in at least one of the following cases: when the device is turned on from a fully off state, when the device is started in a state where operating system and program execution states are stored in memory and the CPU has stopped, and when the device is started in a state where operating system and program execution states are stored on a data storage medium and the CPU has stopped.

In this case, the device is configured so that the application selected by the application selection dial is automatically started when power is turned on, or so that, when a device is restored from a suspended or halt state, the application selected by the application selection dial is preferentially started.

The information processing device according to a third aspect of the present invention is the information processing device according to either the first aspect or second aspect, further comprising a use environment adjuster that, after the application automatic starter starts the application corresponding to the selection position of the application selection dial, adjusts environmental settings to match the settings particular to that application.

In this case, the environmental settings of the information processing device can be set so that the application selected by the application selection can be preferentially used.

The information processing device according to a fourth aspect of the present invention is the information processing device according to any of the first to third aspects, further comprising an IO regulator that, after the application automatic starter starts the application corresponding to the selection position of the application selection dial, enables use of only IO interface for the application.

In this case, an information processing device is configured so that only the specific application selected by the application selection dial can be used.

The information processing device according to a fifth aspect of the present invention is the information processing device according to any of the first through fourth aspects, wherein for each selection position of the application selection dial, one or a plurality of applications can be assigned.

In this case, a device can be configured so that when an information processing device is started, a relevant plurality of applications can be started.

The information processing device according to a sixth aspect of the present invention is the information processing device according to any of the first through fifth aspects, further comprising a decision button for receiving input of user instructions, a start determiner for acquiring from the position detector the current selection position of the application selection dial based on input instructions received by the decision button and determining whether the relevant application has already been activated, an application starter for starting the relevant application in a case where the start determiner has determined that the relevant application has not been activated, and a focus switcher for enabling active display of the relevant application when the start determiner has determined that the relevant application has been activated.

In this case, by simply changing the selection position of the application selection dial and operating the decision button when an information processing device is running, an application can be started, or else an application that has already been started can be positioned at the uppermost window, given full screen display, or otherwise be made available for immediate use.

The information processing device according to a seventh aspect is the information processing device according to any of the first through sixth aspects 6, further comprising a setting acceptor for accepting settings for the correlation between selection positions of the application selection dial and applications for start, and a setting storage unit for storing the correlation settings accepted by the setting acceptor.

In this case, settings for the correlation between application selection dial positions and the applications for start can be made as is appropriate for an individual user's needs.

### A BRIEF EXPLANATION OF THE DRAWINGS

FIG. 1 is an oblique view of the exterior of a notebook PC in which a first embodiment of the present invention has been employed.

FIG. 2 is an enlarged view of the above.

FIG. 3 is a simplified control block diagram of the first embodiment.

FIG. 4 is a functional block diagram relating to the essential components of the first embodiment.

FIG. 5 is a functional block diagram relating to the essential components of the first embodiment.

FIG. 6 is a drawing for explaining the dial settings screen.

FIG. 7 is a control flowchart for the first embodiment.

FIG. 8 is a control flowchart for the first embodiment.

FIG. 9 is a drawing showing the exterior configuration of a second embodiment.

FIG. 10 is a drawing for explaining an environment table.

### BEST MODE FOR WORKING THE INVENTION

It is an object of the present invention to provide an information processing device wherein when power is turned on or when the device is restored from a suspended or halt state, an application can be configured to start easily with a simple operation, without impeding miniaturization of the device.

### First Embodiment

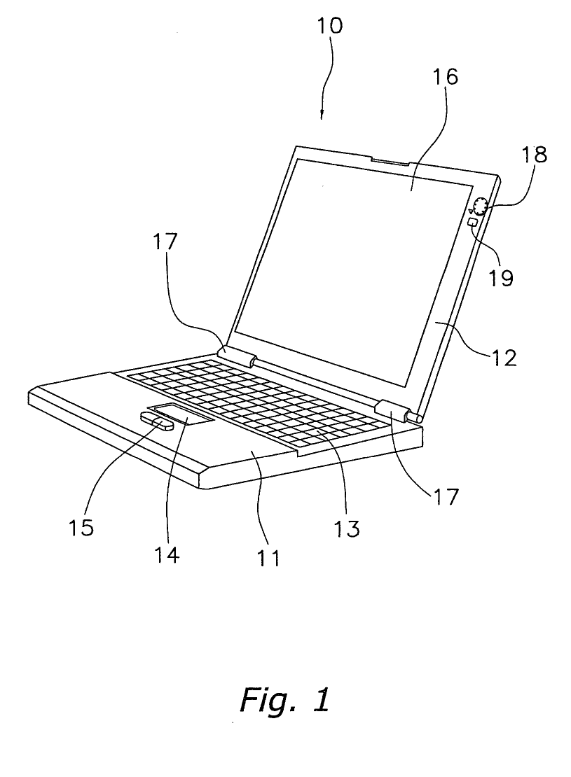

A first embodiment of the present invention will be explained with reference to the drawings. This embodiment contemplates use in a notebook PC as shown in FIG. 1.

A notebook PC 10 is configured so that a body 11 and a lid 12 are connected to each other in a manner allowing rotation via a supporting portion 17. The body 11 has installed therewithin a CPU, ROM, RAM and various interfaces, and comprises a keyboard 13 for receiving data input, a trackpad 14 serving as a pointing device, and a click button 15 for finalizing instructions given through the trackpad 14.

The lid 12 comprises a display 16, which may be a liquid crystal display, organic electroluminescence panel or other flat panel display.

The lid 12 also comprises an application selection dial 18 that is rotatably supported and a decision button 19 for receiving instructions from a user relating to an application selected by the application selection dial 18.

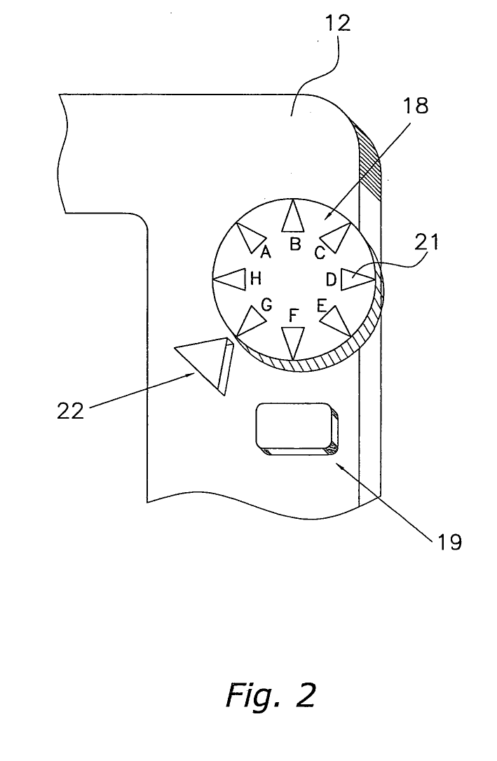

As shown in FIG. 2, the application selection dial 18 is rotatably attached to the housing of the lid 12, and has inscribed thereupon a plurality of reference marks 21 (here, A to H). A selection position indicator 22 for showing the current selection position of the application selection dial 18 is provided near the application selection dial 18, and the application selection dial 18 is configured so that any of these reference marks 21 can stop at the position opposite this selection position indicator 22.

The decision button 19 is for accepting instructions for start of the application corresponding to the current selection position of the application selection dial 18; when this decision button 19 is operated while the notebook PC 10 is in operation, the relevant application will be started.

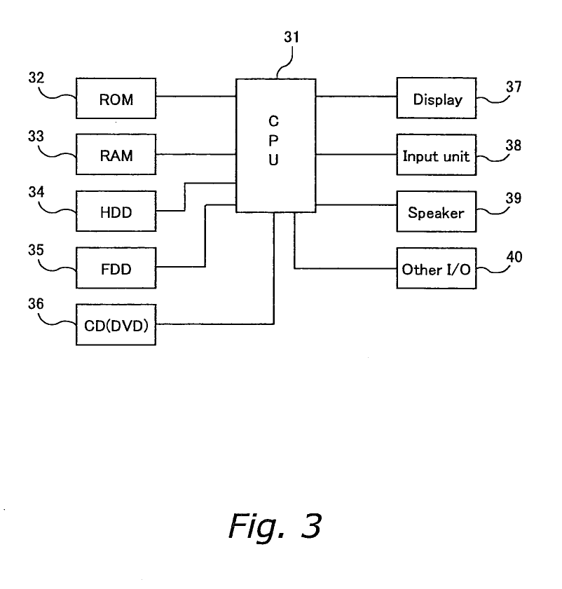

This notebook PC 10 has the configuration of a standard PC; for example, as shown in FIG. 3, it comprises a CPU 31, a ROM 32 storing BIOS and parameters needed for start, a RAM 33 for temporarily storing the various parameters that an operating system and the various applications require, a hard disk drive 34 for storing the operating system, various applications and various data files, a floppy disk drive 35, a CD-ROM drive 36, a display 37 comprising a liquid panel display, an input unit 38 including a keyboard and pointing device, a speaker 39 for outputting music data, sound effects and the like, and interfaces 40 including IEEE1394, USB and other interfaces. The CD-ROM drive 36 may be constituted by a combination drive capable of reading from and writing to a plurality of recording media, including CD-R, CD-RW and DVD.

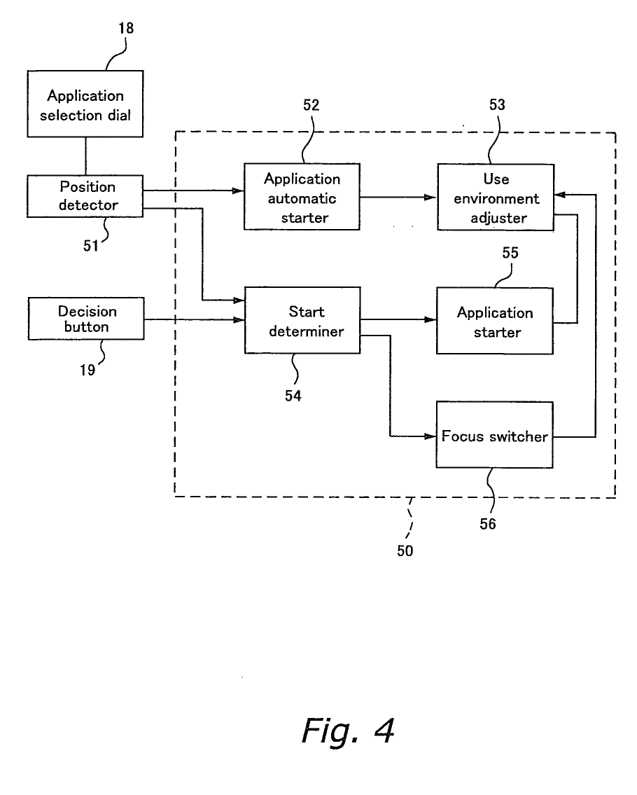

FIG. 4 shows a functional block diagram of the functions for performing automatic start and start control of applications based on the selection position of the application selection dial 18.

The application selection dial 18 may be constituted, for example, by a rotary encoder on which prescribed code patterns are formed on a disk-shaped dial portion, and it may comprise a position detector 51 for acquiring code information based on selection position of the dial portion.

The decision button 19 is for inputting current selection position information of the application selection dial 18 while the notebook PC 10 is in operation; it may be constituted, for example, by a key switch disposed near the application selection dial 18.

Selection position information of the application selection dial 18 acquired by the position detector 51 and instruction input accepted by the decision button 19 are transmitted to a control unit 50.

The control unit 50 may include an application automatic starter 52, a use environment adjuster 53, a start determiner 54, an application starter 55, and a focus switcher 56.

Based on current selection position information of the application selection dial 18 detected by the position detector 51 when power to the notebook PC 10 is turned on, the application automatic starter 52 starts the relevant application.

The start determiner 54 acquires the current selection position information of the application selection dial 18 detected by the position detector 51 when there has been input of instructions from the decision button 19, and determines whether the relevant application has already been activated.

The application starter 55, when it has been determined that the application corresponding to the current selection position of the application selection dial 18 has not been activated, starts the relevant application.

The focus switcher 56, when the application corresponding to the current selection position of the application selection dial 18 has already been activated, opens the relevant application in an active window in an operation-enabled state.

The use environment adjuster 53 prepares the environmental settings required for an application automatically started by the application automatic starter 52, an application started by the application starter 55, or an application opened in an active window by the focus switcher 56. For example, it will make full-screen display of the relevant application, or will change character font and color, brightness and other aspects of the desktop environment to match the specific environmental requirements of the relevant application.

For assigning applications to the reference markings of the application selection dial 18, a dial settings application may be prepared, for example, and a user makes such settings while referring to a setting screen.

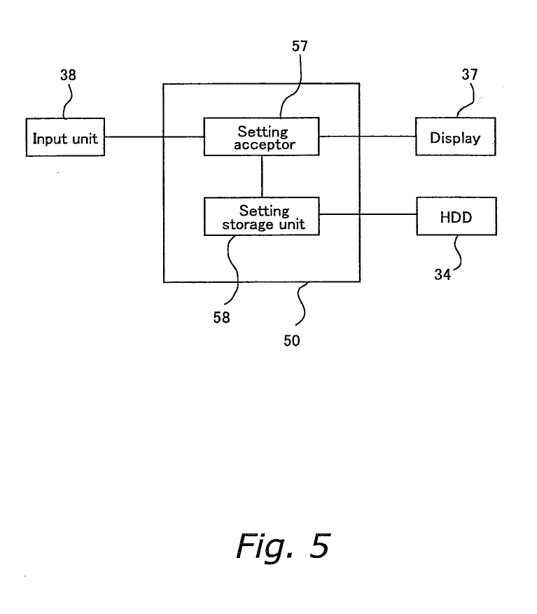

For example, when a dial settings application is started, a setting acceptor 57 as shown in FIG. 5 and a setting storage unit 58 are constituted within the control unit 50.

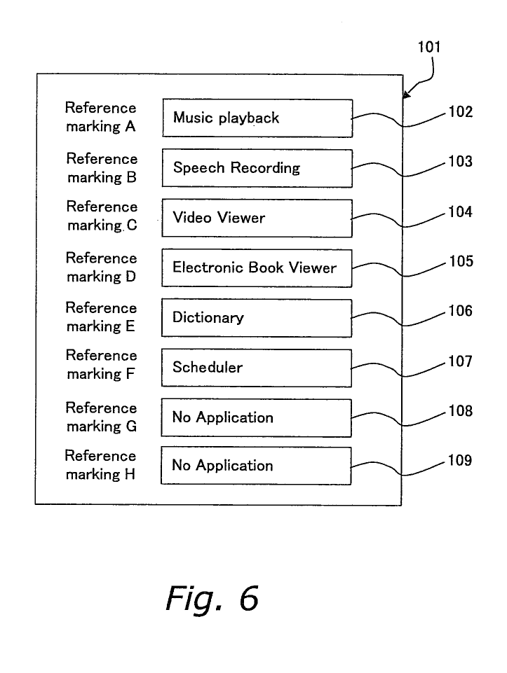

The setting acceptor 57 displays, for example, a dial settings screen 101 as shown in FIG. 6. The dial settings screen 101 comprises application input columns 102 through 109 corresponding respectively to the reference markings A through H of the application selection dial 18. The application input columns 102 through 109 of the dial settings screen 101 accept instructions input from the input unit 38 and display the respective applications assigned to the reference markings A through H. For example, when a user clicks on an application input column using a pointing device, a list of applications available for setting therein is displayed in a pop-down menu; alternatively, input can be made by dragging and dropping a shortcut icon for the application into an application input column. In such a manner the names of the applications assigned to the respective reference markings A through H are displayed in the application input columns 102 through 109. In FIG. 6, the applications “Music Playback,” “Speech Recording,” “Video Viewer, “Electronic Book Viewer,” “Dictionary,” and “Scheduler” are assigned to reference markings A through F respectively, and for reference markings G and H, the indication “No Application” is displayed to indicate that no applications have been assigned thereto. When the selection position of the application selection dial 18 is at a reference marking for “No Application,” automatic start at time of start-up is not executed, and the device will start up in the standard manner.

Setting information accepted by the setting acceptor 57 is stored in a prescribed region of the hard disk drive 34 via the setting storage unit 58. Setting information is information regarding the correspondence between the reference markings A through H of the application selection dial 18 and the applications, as set at the dial settings screen 101; such information is stored on the hard disk drive 34, for example, in the form of a table storing directory information indicating location where the execution file is stored for each application with a reference marking setting.

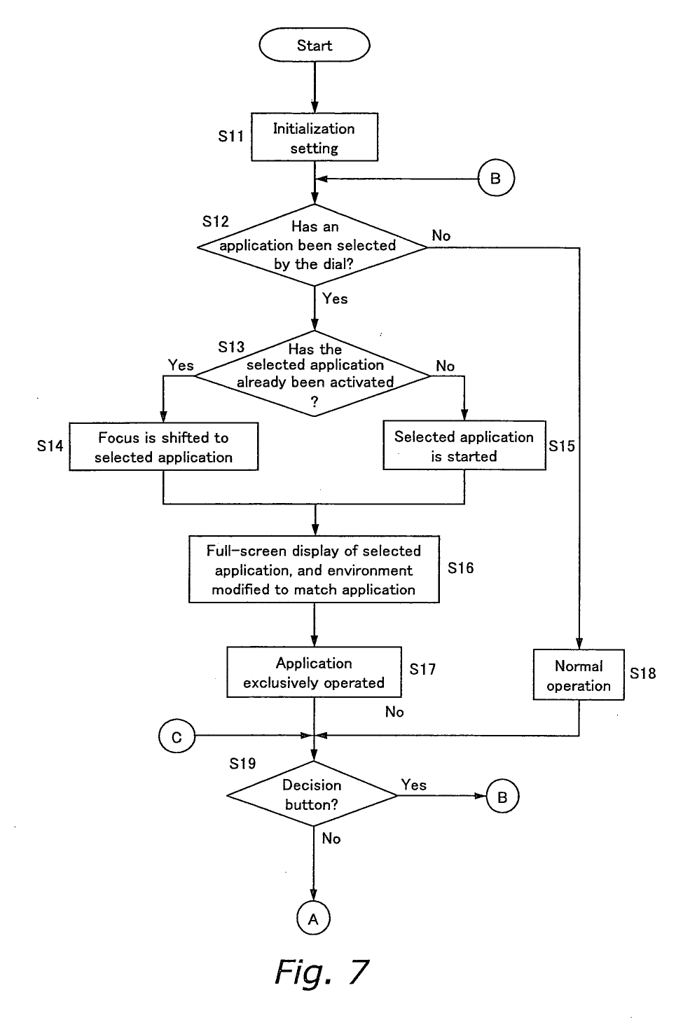

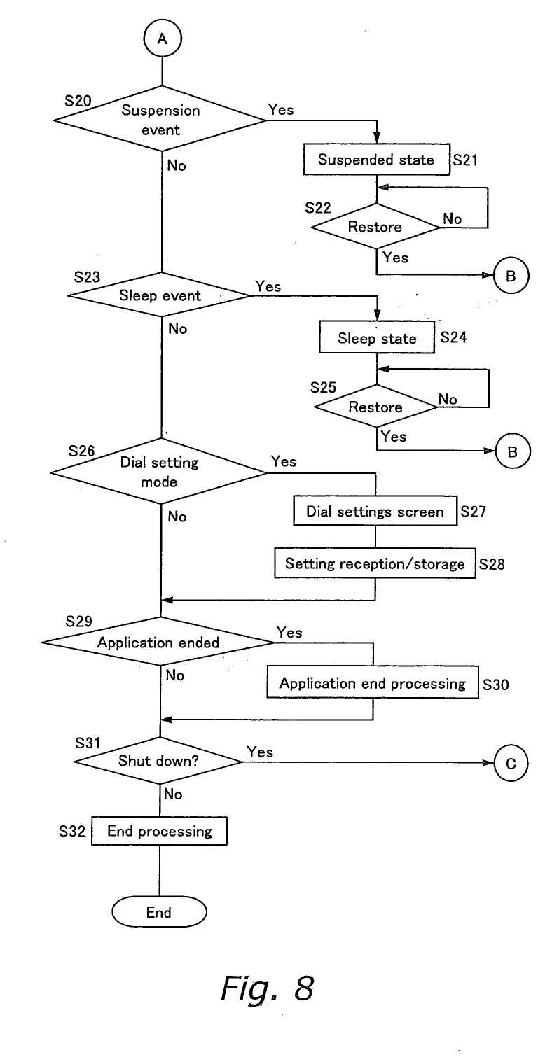

The operations of this embodiment will be explained with reference to the flowcharts of FIGS. 7 and 8.

When power is turned on, in Step S11, various parameters are initialized and initialization is executed. At this time, the position detector 51 acquires current selection position information of the application selection dial 18.

In Step S12, based on current selection position information of the application selection dial 18 acquired by the position detector 51, determination is made of whether an application set for such selection position exists. Reference is made to a table storing information regarding the relationship between the reference markings of the application selection dial 18 and the applications set for such individual markings, and if a relevant application is found to exist, control proceeds to Step S13; if a relevant application is not found to exist, control proceeds to Step S18.

In Step S13, determination is made of whether an application corresponding to the current selection position of the application selection dial 18 has already been activated. If it is determined that such an application is currently running, control proceeds to Step S14, and if it is determined that such an application has not been activated, control proceeds to Step S15.

In Step S14, focus is shifted to the application corresponding to the current selection position of the application selection dial 18. For example, if a plurality of applications are running, and therefore a plurality of windows are open, if the relevant application is a non-active window, such window is made active and is displayed at the highest level.

In Step S15, the application corresponding to the current selection position of the application selection dial 18 is started. Reference is made to a table storing information regarding the relationship between the reference markings of the application selection dial 18 and the applications set for such individual markings, directory information is acquired indicating where the execution file for the relevant application is stored, and this file is executed.

In Step S16, environmental settings particular for the selected application are made. For example, as described above, the relevant application will be given full-screen display, or character font and color, brightness and other aspects of the desktop environment will be changed to match the specific environmental requirements of the relevant application.

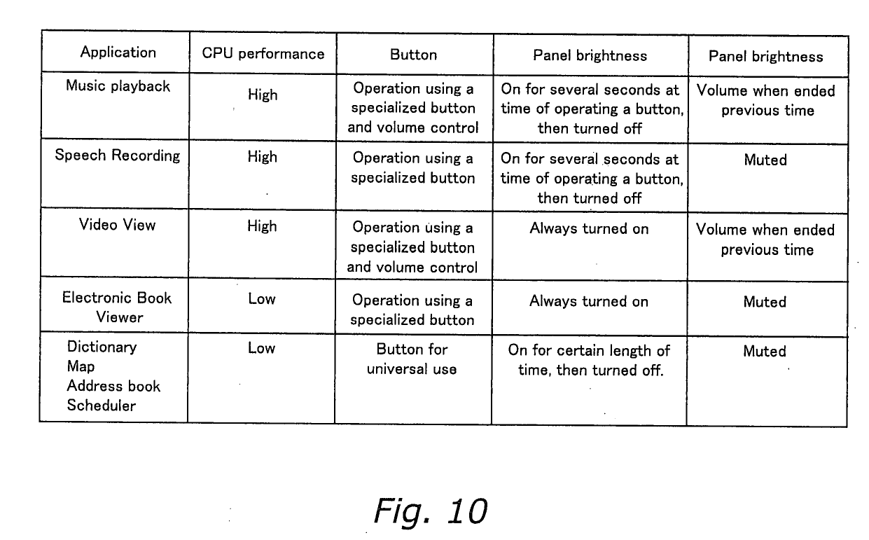

Other conceivable setting adjustments include, depending on the CPU performance required for an application to run, adjusting the brightness of the display unit 37 and adjusting the volume of the speaker 39. For example, with a configuration in which an environmental settings table as shown in FIG. 10 is stored in a prescribed region of the hard disk drive 34, if the selected application is an application for music playback, the backlight of the liquid crystal display panel may be caused to light for several seconds during button operation, and then turn off. For applications not requiring audio output, a mute mode setting may be made to stop output to the speaker 39.

In Step S17, the selected application is exclusively operated. The selected application is set in an active window, or else given full screen display, and the application is available for immediate operation, or if settings have been made for automatic execution of a task that task is automatically executed.

In Step S18, normal operational mode is executed without application automatic start or focus shift.

In Step S19, determination is made of whether the decision button 19 has been operated. If input of user instructions has been accepted via the decision button 19, control returns to Step S12, and based on current selection position of the application selection dial 18, the relevant application is started or focus is shifted thereupon. If it is determined that the decision button 19 has not been operated, control proceeds to Step S20.

In Step S20, determination is made of whether an event has occurred that would cause the operating mode of the notebook PC 10 to shift to a state of suspension. If a user has given instructions for suspension mode, or if a prescribed length of time has passed without user operation input, or if any other suspension event for controlling energy consumption has occurred, control proceeds to Step S21. In all other cases, control proceeds to Step S23.

In Step S21, the operating mode of the notebook PC 10 is shifted to a state of suspension. A suspended state is a power-saving mode in which, when computer use is temporarily suspended, task states are stored in system memory, operating system and program operating states are stored in the RAM 33, and the CPU 31 has stopped. This suspended state may be also called stand-by mode, resume function or the like.

In Step S22, determination is made of whether any event has occurred that would cause restoration from the suspended state. If a user has input restore instructions, or if wake-up instructions have been made from an application using a timer setting, control returns to Step S12.

In Step S23, determination is made of whether an event has occurred that would cause the operating mode of the notebook PC 10 to shift to a halt state. If a user has given instructions for a halt state, if settings for a halt state have been made and a prescribed length of time has passed without user operation input, or if any other suspension event for restraining energy consumption has occurred, control proceeds to Step S24. In all other cases, control proceeds to Step S26.

In Step S24, the operating mode of the notebook PC 10 is shifted to a halt state. A halt state is a state in which, when computer use has been temporarily suspended, task states are stored on the hard disk drive 34, operating system and program operating states are stored on the hard disk drive 34, and the CPU 31 has stopped.

In Step S25, determination is made of whether any event has occurred that would cause restoration from the halt state. If a user has input restore instructions, or if wake-up instructions have been made from an application using a timer setting, control returns to Step S12.

In Step S26, determination is made of whether application setting mode for the reference markings of the application selection dial 18 has been selected. For example, if a dial settings application as described above has been started, control proceeds to Step S27.

In Step S27, based on operations of the dial settings application, a dial settings screen 101 is displayed on the display 37 (see FIG. 6).

In Step S28, application settings are accepted for the reference markings of the application selection dial 18, and a corresponding table is stored. As described above, on the dial settings screen 101 as shown in FIG. 6, settings are accepted for correspondence between the various reference markings and the respective applications, and a corresponding table is stored in a prescribed region of the hard disk drive 34.

In Step S29, determination is made of whether an end instruction has been given with respect to an application that is running. If it is determined that a user has given end instructions with respect to a running application, control proceeds to Step S30.

In Step S30, data created by the running application is stored on a prescribed region of the hard disk drive 34 and/or various parameters are stored in the hard disk drive 34 as necessary, and the application for which the instructions were given is ended.

In Step S31, determination is made of whether shutdown instructions have been given to the notebook PC 10. If it is determined that shutdown instructions have been made, control proceeds to Step S32. In all other cases, control returns to Step S19.

In Step S32, the executed application is ended, created data and/or various parameters are stored as necessary on a prescribed region of the hard disk drive 34, and the device is shut down.

In such an embodiment 1, when the notebook PC 10 is turned on, the application set at the selection position of the application selection dial 18 is automatically started, and operation of a desired application is automatically started without any complicated operation.

Also, while the notebook PC 10 is running, the application selection dial 18 and decision button 19 can be operated to start a desired application or restore it to an active window, allowing easy start of an application.

Further, a device may be configured so that, if it has power-saving modes such as suspended or halt state, at time of restoration, the application corresponding to the selection position of the application selection dial 18 is started, or focus is shifted to such application, allowing speedy start-up of the application.

### Second Embodiment

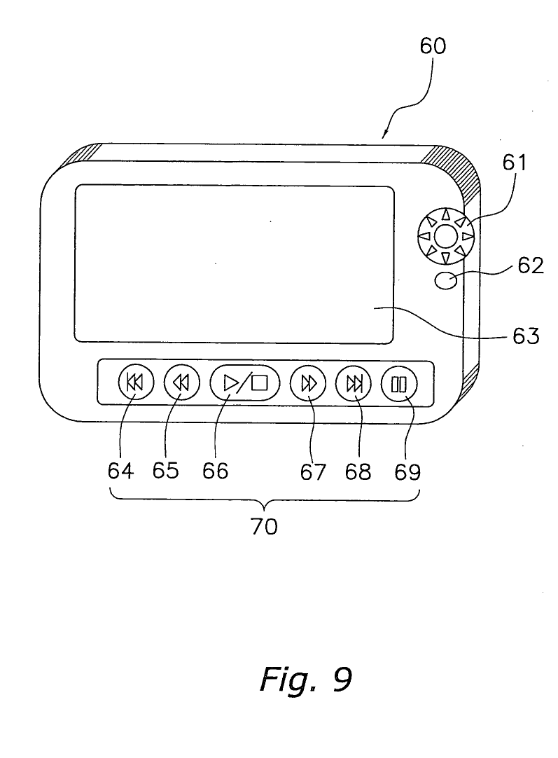

A second embodiment of the present invention will be explained with reference to FIG. 9.

The second embodiment contemplates use of a portable information terminal such as a PDA as an information processing device; however, no particular limitations are made in such regard, as this embodiment can be also applied to a notebook or desktop PC.

An information processing device 60 includes a display 63, which may be a liquid crystal display, plasma display or other flat panel display, and comprises an application selection dial 61 and a decision button 62 identical to those of the first embodiment.

The information processing device 60 also comprises operational keys 70 that have been made application-specific. The operational keys 70, for example, in correspondence with an application for music playback or video viewer, comprise a previous button 64 for giving instructions for playback of a previous item, a rewind button 65 for giving instructions for rewind, a playback/stop button 66 for giving instructions for playback and stop, a fast-forward button 67 for giving instructions for fast-forward, a next button 68 for giving instructions for playback of the next item, and a pause button 69 for giving instructions for a temporary stop.

Such a second embodiment can be constituted, as with the first embodiment, so as to operate in the manner set forth in the flowcharts of FIGS. 7 and 8.

However, a device may be configured such that in cases where the operational keys are used with the selected application, only input from the operational keys 70 is accepted, and in cases where the operational keys 70 are not used with the relevant application, input from the operational keys 70 is prohibited and only instructions from an input unit for universal use are accepted. In this case, an environmental settings table as shown in FIG. 10 is stored in advance in a prescribed region of a hard disk drive, and in Step S16, reference is made to this environmental settings table to regulate input interfaces. For example, in the case of music playback, speech recording, video viewer, electronic book viewer, and other applications using the operational keys 70, operation of buttons for universal use is regulated, and input only from the operational keys 70 and a volume control button (not shown in the drawings) is accepted. For dictionaries, maps, address books, schedulers, and other applications not using the operational keys 70, input from the operational keys 70 is regulated and input only from a button for universal use is accepted.

Because it is likely that the information processing device 60 will frequently run on battery power, to reduce energy consumption as much as possible, it can be configured so that except for applications such as a video viewer or electronic book viewer that are continuously displayed on the display, the backlight of a liquid crystal panel is caused to light for several seconds during button operation and then turn off. It can also be configured so that, except for the applications requiring audio output such as music playback or video viewer, output to the speaker is muted.

With such a second embodiment of the present invention, operational keys 70 specific to the selected application can be used for operation, improving operability.

### Other Embodiments

(A) If a display 37 is a touch panel, and input instructions can be made by tapping the display screen, the decision button 19 need not be provided. In such a case, because a decision button is not needed, further miniaturization can be achieved.

(B) A lock mechanism may be provided for locking the selection position of the application selection dial 18. For example, grooves are provided for each reference marking on the peripheral surface of the dial of the application selection dial 18, and a claw for engaging with the grooves is provided on the body. In this case, the application selection dial 18 is prevented from being maliciously or accidentally rotated away the selection position desired by a user.

(C) When an information processing device is to shut down, shift to a suspended state, or shift to a halt state, the current selection position of the application selection dial 18 is stored, and when power is turned on or the device is restored to an operating state, the relevant application for the stored selection position of the application selection dial 18 is started. In this case, even if the application selection dial 18 was turned when the information processing device was not running, the relevant application is started based on the stored position information. The device may configured so that, if a user wishes to start an application other than the application for the selection position of the application selection dial 18 at time of shut down, shift to a suspended state, or shift to a halt state, the user can start the desired application by pressing down the decision button 19 when power is turned on or the device is restored to an operating.

With the present invention, when power is turned on or when the device is restored from a suspended or halt state, a desired application can be automatically started, allowing speedy start-up of an application with a simple operation.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

1. An information processing device onto which a plurality of applications can be loaded, comprising:
an application selection dial rotatably attached to a housing and capable of stopping at a plurality of selection positions;
a position detector for detecting selection position of the application selection dial; and
an application automatic starter that starts an application among such plurality of applications, the application being assigned to the selection position detected by the position detector at time of start-up.

2. The information processing device according to claim 1, wherein the application automatic starter starts an application in at least one of the following cases: when the device is turned on from a fully off state, when the device is started in a state where operating system and program execution states are stored in memory and the CPU has stopped, and/or when the device is started in a state where operating system and program execution states are stored on a data storage medium and the CPU has stopped.

3. The information processing device according to either claim 1 or claim 2, further comprising a use environment adjuster that, after the application automatic starter starts the application corresponding to the selection position of the application selection dial, adjusts environmental settings to match the settings particular to that application.

4. The information processing device according to claim 1 or 2, further comprising an IO regulator that, after the application automatic starter starts the application corresponding to the selection position of the application selection dial, enables use of only IO interface for the application.

5. The information processing device according to claim 1 or 2, wherein for each selection position of the application selection dial, one or a plurality of applications can be assigned.

6. The information processing device according to claim 1 or 2, further comprising:
a decision button for receiving input of user instructions;
a start determiner for acquiring from the position detector the current selection position of the application selection dial based on input instructions received by the decision button and determining whether the relevant application has already been activated;
an application starter for starting the relevant application in a case where the start determiner has determined that the relevant application has not been activated; and
a focus switcher for enabling active display of the relevant application when the start determiner has determined that the relevant application has been activated.

7. The information processing device according to claim 1 or 2, further comprising a setting acceptor for accepting settings for the correlation between selection positions of the application selection dial and applications for start, and a setting storage unit for storing the correlation settings accepted by the setting acceptor.

8. The information processing device according to claim 3, further comprising an IO regulator that, after the application automatic starter starts the application corresponding to the selection position of the application selection dial, enables use of only IO interface for the application.

9. The information processing device according to claim 3, wherein for each selection position of the application selection dial, one or a plurality of applications can be assigned.

10. The information processing device according to claim 4, wherein for each selection position of the application selection dial, one or a plurality of applications can be assigned.

11. The information processing device according to claim 3, further comprising:
a decision button for receiving input of user instructions;
a start determiner for acquiring from the position detector the current selection position of the application selection dial based on input instructions received by the decision button and determining whether the relevant application has already been activated;
an application starter for starting the relevant application in a case where the start determiner has determined that the relevant application has not been activated; and
a focus switcher for enabling active display of the relevant application when the start determiner has determined that the relevant application has been activated.

12. The information processing device according to claim 4, further comprising:
a decision button for receiving input of user instructions;
a start determiner for acquiring from the position detector the current selection position of the application selection dial based on input instructions received by the decision button and determining whether the relevant application has already been activated;
an application starter for starting the relevant application in a case where the start determiner has determined that the relevant application has not been activated; and
a focus switcher for enabling active display of the relevant application when the start determiner has determined that the relevant application has been activated.

13. The information processing device according to claim 5, further comprising:
a decision button for receiving input of user instructions;
a start determiner for acquiring from the position detector the current selection position of the application selection dial based on input instructions received by the decision button and determining whether the relevant application has already been activated;
an application starter for starting the relevant application in a case where the start determiner has determined that the relevant application has not been activated; and
a focus switcher for enabling active display of the relevant application when the start determiner has determined that the relevant application has been activated.

14. The information processing device according to claim 3, further comprising a setting acceptor for accepting settings for the correlation between selection positions of the application selection dial and applications for start, and a setting storage unit for storing the correlation settings accepted by the setting acceptor.

15. The information processing device according to claim 4, further comprising a setting acceptor for accepting settings for the correlation between selection positions of the application selection dial and applications for start, and a setting storage unit for storing the correlation settings accepted by the setting acceptor.

16. The information processing device according to claim 5, further comprising a setting acceptor for accepting settings for the correlation between selection positions of the application selection dial and applications for start, and a setting storage unit for storing the correlation settings accepted by the setting acceptor.

17. The information processing device according to claim 6, further comprising a setting acceptor for accepting settings for the correlation between selection positions of the application selection dial and applications for start, and a setting storage unit for storing the correlation settings accepted by the setting acceptor.
